(19) United States
(12) Patent Application Publication
(10) Pub. No.: US 2022/0200943 A1
(43) Pub. Date: Jun. 23, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Rahul ARUNA PUGALENDHI, Kanagawa (JP)

(73) Assignee: FUJIFILM Business Innovation Corp., Tokyo (JP)

(21) Appl. No.: 17/344,926

(22) Filed: Jun. 10, 2021

(30) Foreign Application Priority Data
Dec. 23, 2020 (JP) 2020-213559

(51) Int. Cl. H04L 12/58; G06F 3/0484

(52) U.S. Cl. CPC H04L 51/18; G06F 3/04842

(57) ABSTRACT

An information processing apparatus includes a processor configured to acquire a message communicated via a communication means between plural users, execute a process mentioned in the message on a target mentioned in the message, and perform a control to display that the process has been performed on the target.

### CROSS-REFERENCE TO RELATED APPLICATIONS

This application is based on and claims priority under 35 USC 119 from Japanese Patent Application No. 2020-213559 filed Dec. 23, 2020.

### BACKGROUND

### (i) Technical Field

The present invention relates to an information processing apparatus and a non-transitory computer readable medium storing a program.

### (ii) Related Art

US2015/0256493 describes a system and a method for processing a document, the method and the system including: sending a message and an attached document by a user to a computer-based system with a natural language instruction attached to the subject or body of the message, or as a script; interpreting the subject and body of the message after user authentication; identifying document processing activities to be performed; and processing attached or referenced documents, in response to an instruction from a document processing server, by using the identified document processing activities.

U.S. Ser. No. 10/686,951 describes a method and a system for accessing print and scan functions of a multifunction printer, the method and the system including: receiving a text or voice message expressed in natural language and received from one or more servers from a mobile device of a user of the multifunction printer; extracting text data or audio data of the received text or voice message; transfer the extracted text or audio data of the received text or voice message to the one or more servers; receiving, from the one or more servers, one or more entities or intents related to a text or voice message based on a process of the text or audio data by one or more servers; processing the entities or intents to determine one or more functions related to the text or voice message from the mobile device of the user of the multifunction printer; and controlling the function of the multifunction printer by performing one or more determined functions.

### SUMMARY

A message communicated via a communication means between a plurality of users may mention that a certain process is to be executed on a certain target. In this case, in order to execute the process on the target, the user needs to execute the process on the target, separately from the communication of the message by using the communication means.

Aspects of non-limiting embodiments of the present disclosure relate to an information processing apparatus and a non-transitory computer readable medium storing a program, capable of reducing the time and effort of an operation to be performed by a user, in a case where a message communicated via a communication means between a plurality of users mentions that a certain process is to be executed on a certain target, as compared with a case where the user executes the process on the target, separately from the communication of the message by using the communication means.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to acquire a message communicated via a communication means between a plurality of users, execute a process mentioned in the message on a target mentioned in the message, and perform a control to display that the process has been performed on the target.

### BRIEF DESCRIPTION OF THE DRAWINGS

Exemplary embodiment(s) of the present invention will be described in detail based on the following figures, wherein:

FIG. 1 is a diagram illustrating an example of an overall configuration of a computer system to which an exemplary embodiment of the present invention is applied;

FIG. 2 is a diagram illustrating a hardware configuration example of a server according to the exemplary embodiment of the present invention;

FIG. 3 is a diagram illustrating an example of a screen displayed in a first scenario on a client in the exemplary embodiment of the present invention;

FIG. 4 is a diagram illustrating an example of a screen displayed in the first scenario on the client in the exemplary embodiment of the present invention;

FIG. 5 is a diagram illustrating an example of a screen displayed in the first scenario on the client in the exemplary embodiment of the present invention;

FIG. 6 is a diagram illustrating an example of a screen displayed in a second scenario on the client in the exemplary embodiment of the present invention;

FIG. 7 is a diagram illustrating an example of a screen displayed in the second scenario on the client in the exemplary embodiment of the present invention;

FIG. 8 is a diagram illustrating an example of a screen displayed in the second scenario on the client in the exemplary embodiment of the present invention;

FIG. 9 is a diagram illustrating an example of a screen displayed in the second scenario on the client in the exemplary embodiment of the present invention;

FIG. 10 is a diagram illustrating an example of a screen displayed in a third scenario on the client in the exemplary embodiment of the present invention;

FIG. 11 is a diagram illustrating an example of a screen displayed in the third scenario on the client in the exemplary embodiment of the present invention;

FIG. 12 is a block diagram illustrating a functional configuration example of the server according to the exemplary embodiment of the present invention; and

FIG. 13 is a flowchart illustrating an operation example of the server according to the exemplary embodiment of the present invention.

### DETAILED DESCRIPTION

Hereinafter, exemplary embodiments of the present invention will be described in detail with reference to the accompanying drawings.

Overall Configuration of Computer System

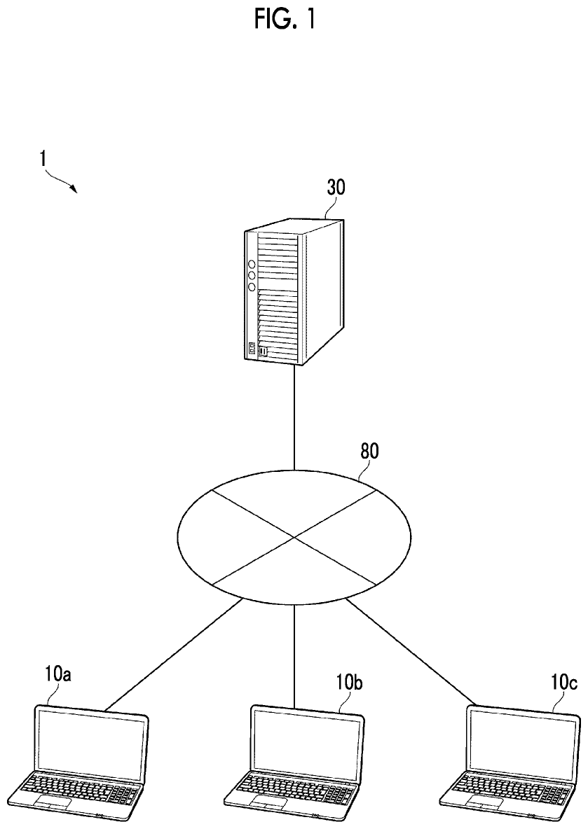

FIG. 1 is a diagram illustrating an overall configuration example of a computer system 1 to which the present exemplary embodiment is applied. As illustrated in FIG. 1, a computer system 1 is configured by connecting clients 10a to 10c and a server 30 via a communication line 80. Although the clients 10a to 10c are illustrated in FIG. 1, in a case where there is no need to distinguish between the clients 10a to 10c, the clients 10a to 10c may be referred to as the client 10. Further, although only three clients 10 are illustrated in FIG. 1, four or more clients 10 may be provided.

The client 10 is a computer used by a user who uses the computer system 1. An application for using a service provided by the computer system 1 is installed on the client 10, and the client 10 is operated by, for example, a user's start operation. As the client 10, for example, a personal computer, a tablet terminal, a smartphone, or the like may be used.

The server 30 is a computer that provides a service to the user through the client 10 in response to a request sent from the client 10 by the user's operation. As the server 30, for example, a general-purpose personal computer may be used. In the present exemplary embodiment, the server 30 is provided as an example of the information processing apparatus.

The communication line 80 is a line used for information communication between the client 10 and the server 30. As the communication line 80, for example, the Internet may be used.

Server Hardware Configuration

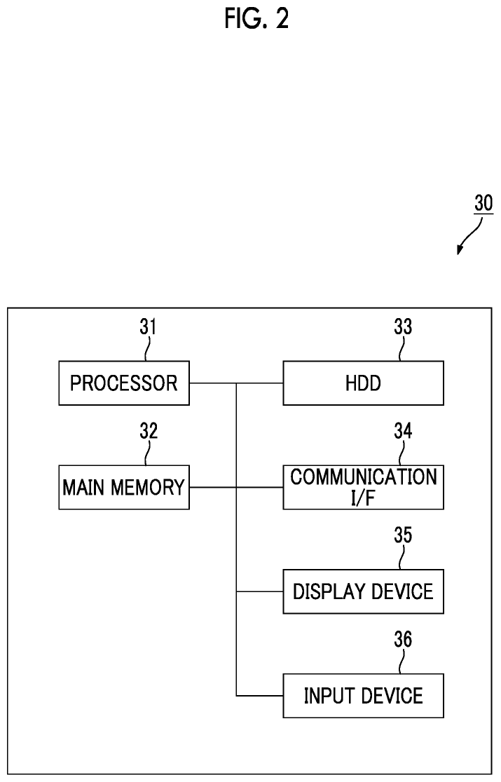

FIG. 2 is a diagram illustrating a hardware configuration example of the server 30 according to the present exemplary embodiment. As illustrated in FIG. 2, the server 30 includes a processor 31, a main memory 32, and a Hard Disk Drive (HDD) 33. Here, the processor 31 executes various software such as an Operating System (OS) and an application, and achieves each function described later. The main memory 32 is a storage area for storing various software and data used for executing the software, and the HDD 33 is a storage area for storing input data to various software and output data from various software. Further, the server 30 includes a communication I/F (hereinafter, referred to as “I/F”) 34 for communicating with the outside, a display device 35 such as a display, and an input device 36 such as a keyboard and a mouse.

Further, the hardware configuration illustrated in FIG. 2 can also be regarded as the hardware configuration of the client 10. However, when describing the client 10, the processor 31, the main memory 32, the HDD 33, the communication I/F 34, the display device 35, and the input device 36 in FIG. 2 are referred to as the processor 11, the main memory 12, the HDD 13, the communication I/F 14, the display device 15, and the input device 16, respectively.

### Outline of Present Exemplary Embodiment

In the present exemplary embodiment, the server 30 acquires a message communicated via a communication means between a plurality of users, executes a process mentioned in the message on a target mentioned in the message; and performs a control to display that the process has been performed on the target.

Here, the communication means may be any communication means as long as it is a unit for communicating a message between a plurality of users. Further, the message may be any message as long as it is a message communicated between a plurality of users. Examples of the communication means include chat, e-mail, telephone, or the like, and some messages may be communicated by these communication means, and in the following, chat is taken as an example of the communication means, and a chat message is described as an example of a message. However, in the following, the “chat message” is also simply referred to as a “message”.

The target may be any target as long as it is a target to be processed. The target includes document data, image data, and the like. In the following, document data (hereinafter, simply referred to as “document”) will be described as an example.

The process may be any process as long as it is performed on the target. The process includes a process of pressing a stamp on a document (also referred to as a “signing process”), a process of sending a document to a destination, and the like.

Mention refers to talking about the conversation in a message, whether explicit or implied. That is, mention includes not only the explicit designation in the message but also the ambiguous statement in a message. Ambiguous statement in a message refers to that it is not explicitly designated in the message, but is stated in a form that can be understood from the context of the message. In a case of requesting for an approval for “No. 123 application”, an explicit designation in the message refers to, for example, “Please approve the No. 123 application”, and an ambiguous statement in the message refers to, for example, “Please approve the application I mentioned the other day.” Further, the mention includes not only requesting another user to perform some process, but also notifying the other user that he/she will execute some process. An example of the latter is “make a copy of the photo and give it to everyone.”

Further, in the present exemplary embodiment, in a case where there are a plurality of process candidates as candidates for processes, the server 30 executes one process candidate selected from the plurality of process candidates on the target. Here, the plurality of process candidates may be different processes. In this case, examples of the plurality of candidates for processes include a plurality of processes such as a process of pressing a stamp designated on a document and a process of sending a document to a designated destination. Further, the plurality of process candidates each may perform a process by using data corresponding to each process candidate among the plurality of data pieces. That is, the plurality of process candidates may be identical process but use different data pieces in the process. In this case, examples of the plurality of candidates for processes include a plurality of processes using different stamps in the process of pressing a stamp on a document. Alternatively, examples of the plurality of candidates for processes may include a plurality of processes using different destinations in the process of sending the document to the destination. The stamp and the destination are examples of data used in the process.

Further, in the present exemplary embodiment, in a case where there are a plurality of target candidates as candidates for the target, the server 30 executes a process on one target candidate selected from the plurality of target candidates on the target. Here, the plurality of target candidates may be a plurality of documents, in a case where the target is a document. Alternatively, the plurality of target candidates may be a plurality of pages of one document or a plurality of locations of one document, in a case where the target is a document. However, in the following, a plurality of documents will be described as an example.

### SPECIFIC EXAMPLE OF PRESENT EXEMPLARY EMBODIMENT

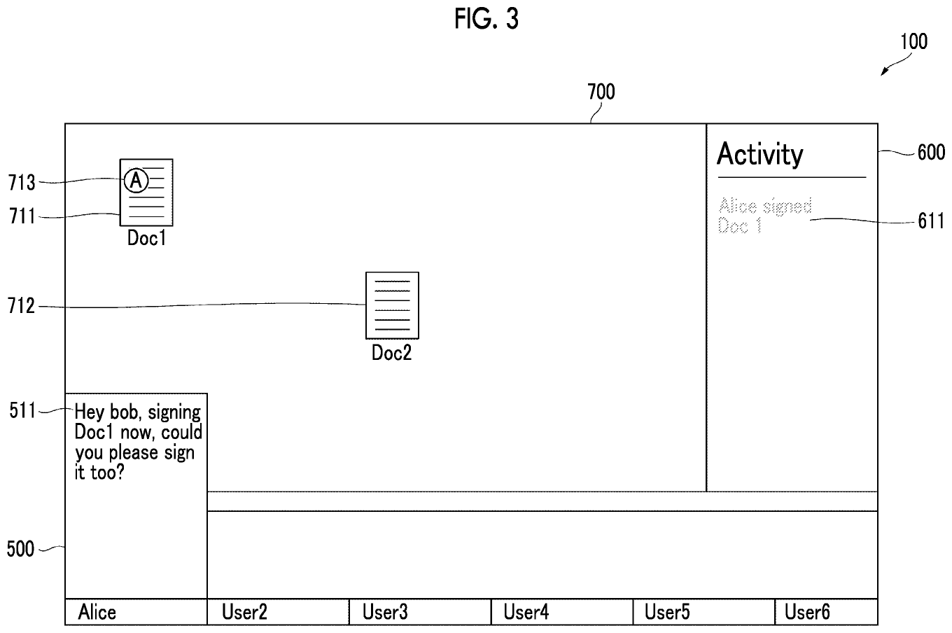

FIGS. 3 to 11 are diagrams illustrating examples of a screen 100 displayed on the client 10 in the present exemplary embodiment. As illustrated in FIGS. 3 to 11, the screen 100 includes a chat display field 500, a process history display field 600, and a processed image display field 700.

The chat display field 500 is a field for displaying a chat message or the like communicated between a plurality of users or between the server 30 and the user.

The process history display field 600 is a field for displaying the process history, which is the history of the process performed by the server 30. In a case where the process performed by the server 30 is a process instructed by the user who uses the client 10, the process history is displayed in the process history display field 600 with “you” as the subject. In a case where the process performed by the server 30 is a process instructed by a user other than the user who uses the client 10, the process history is displayed in the process history display field 600 with the name of the other user as the subject.

The processed image display field 700 is a field for displaying a processed image, which is an image representing the process performed by the server 30. In the processed image display field 700, an icon representing a document is displayed, and an icon representing the processing content for the document is displayed in association with the icon.

First, the screen 100 displayed in the first scenario will be described. The first scenario is a scenario in which Alice presses a stamp on a document and asks Bob to press the stamp on the document.

FIG. 3 illustrates an example of a screen 100 displayed on Bob's client 10 in a case where Alice presses a stamp on “Doc1” and asks Bob to press the stamp on “Doc1”. At this time, in the chat display field 500, Alice's message 511 “Hey bob, signing Doc1 now, could you sign it too?” is displayed. Further, in the process history display field 600, a process history 611 saying “Alice signed Doc1” is displayed. Here, since the process history 611 is not the history of the process instructed by Bob, it is grayed out and displayed. Further, in the processed image display field 700, it is indicated that the Alice's stamp is pressed on the “Doc1” by displaying the Alice's stamp icon 713 superimposed on the “Doc1” icon 711.

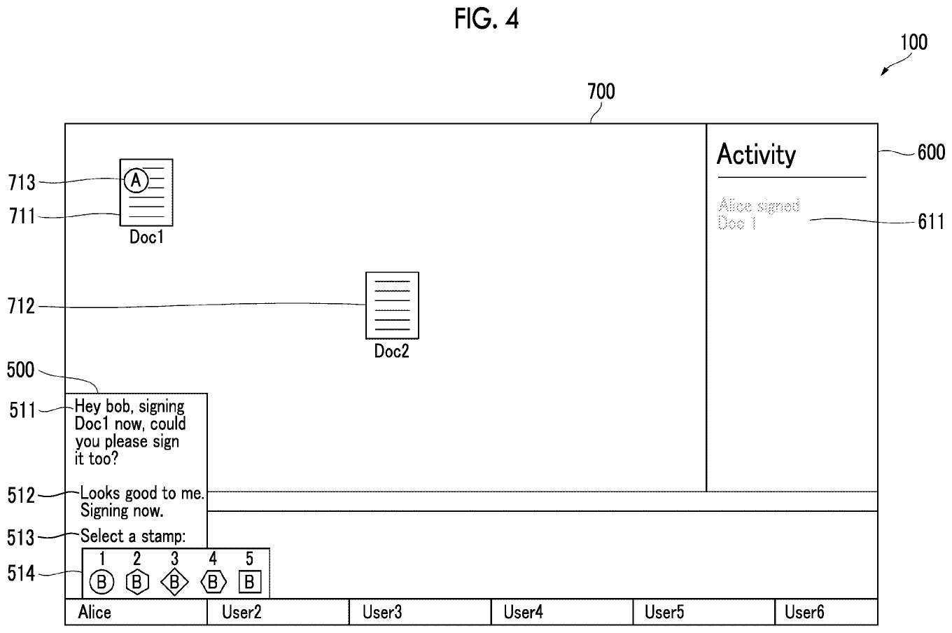

FIG. 4 illustrates an example of a screen 100 displayed on Bob's client 10 in a case where Bob presses a stamp on “Doc1” in response to Alice's request. At this time, in the chat display field 500, Bob's message 512 “Looks good to me. Signing now.” is displayed. However, in this example, it is assumed that Bob has a plurality of stamps. Therefore, in the chat display field 500, the message 513 “Please select a stamp” of the server 30 and the stamp option 514 consisting of “Stamp 1” to “Stamp 5” are further displayed.

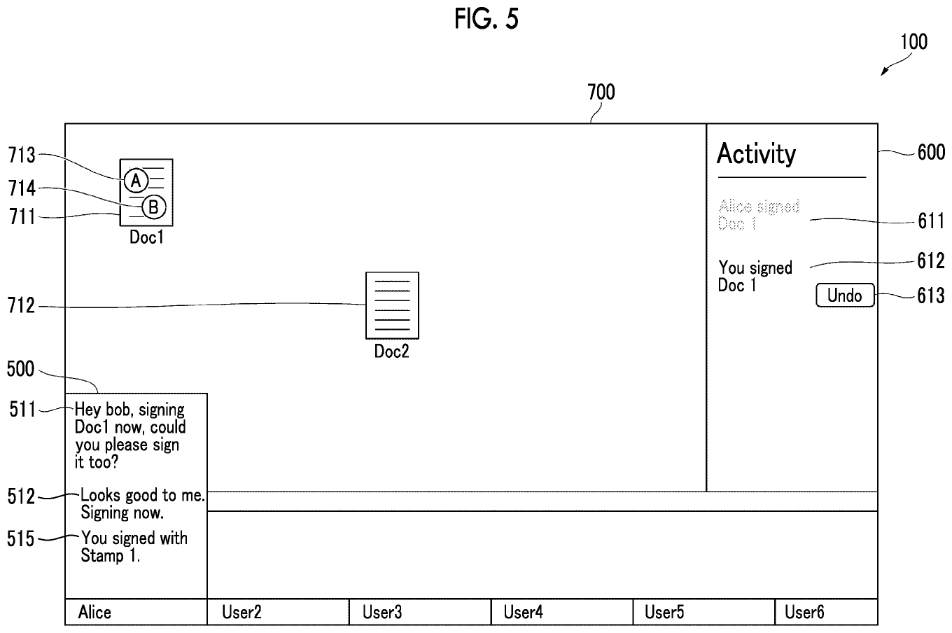

FIG. 5 illustrates an example of the screen 100 displayed on Bob's client 10 in a case where Bob selects “Stamp 1” and presses “Stamp 1” on “Doc1”. At this time, in the chat display field 500, the message 515 of the server 30 “You have signed with Stamp 1” is displayed. Further, in the process history display field 600, a process history 612 saying “You signed Doc1” and an “Undo” button 613 for canceling the process indicated by the process history 612 are displayed. This allows Bob to cancel the process he has instructed in message 512 by clicking the “Undo” button 613. On the other hand, since the “Undo” button is not displayed in the process history display field 600 on the screen 100 of Alice's client 10, Alice cannot cancel the process instructed by Bob. Further, in the processed image display field 700, it is indicated that “Stamp 1” is further pressed on “Doc1” by displaying the Bob's “stamp 1” icon 714 superimposed on the “Doc1” icon 711.

Next, the screen 100 displayed in the second scenario will be described. The second scenario is a scenario in which Alice asks Bob to press a stamp on a document, but the content of the request is ambiguous.

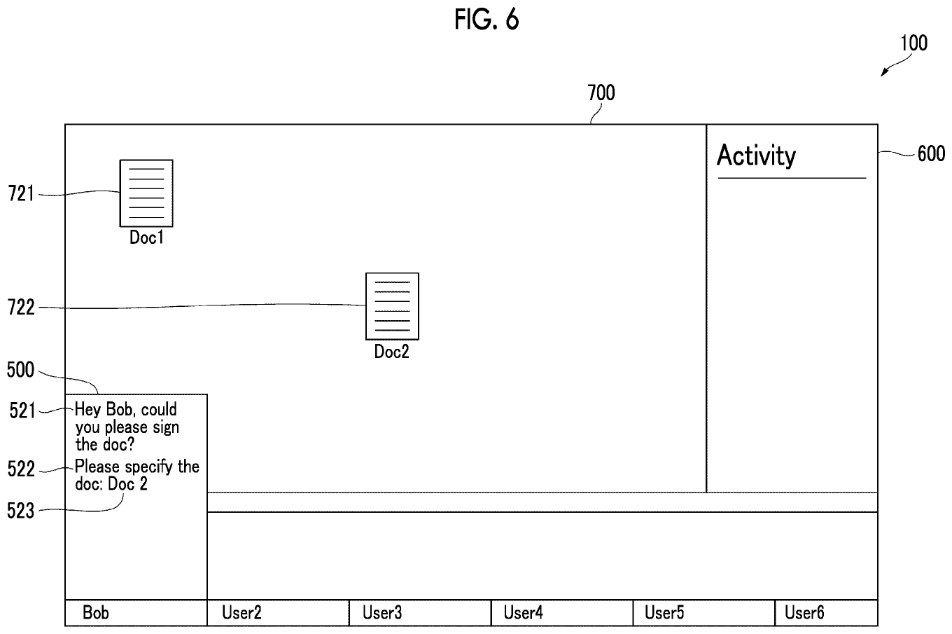

FIG. 6 illustrates an example of a screen 100 displayed on Alice's client 10 in a case where Alice asks Bob to press a stamp. At this time, in the chat display field 500, Alice's message 521 “Bob, would you sign the document?” is displayed. However, the document is not designated in this message 521. Therefore, in the chat display field 500, the message 522 of the server 30 “Please specify the doc” is displayed. Then, in response to this message 522, Alice inputs the message 523 “Doc2”.

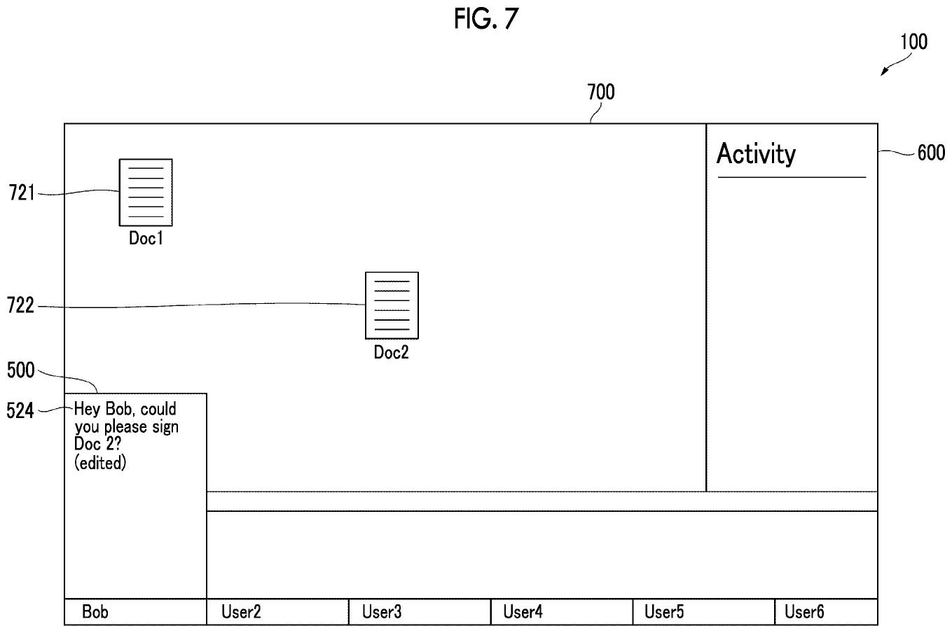

FIG. 7 illustrates an example of a screen 100 displayed on Alice's client 10 in a case where Alice inputs “Doc2”. At this time, in the chat display field 500, Alice's message 524 “Hey bob, could you please sign Doc2?” is displayed. This message 524 is an edited version of the message 521 in a case where Alice inputs the message 522 “Doc2” in FIG. 6.

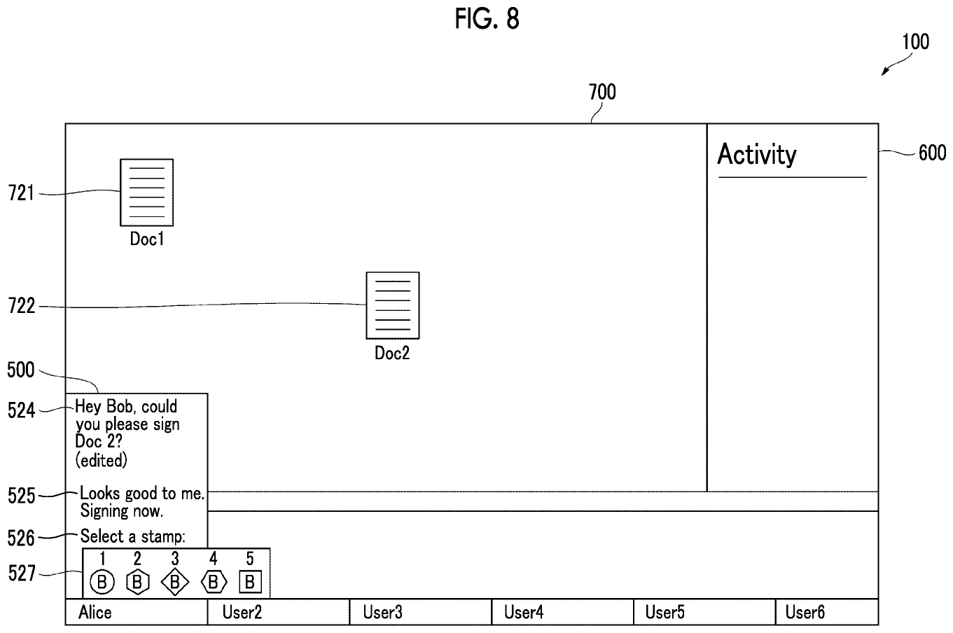

FIG. 8 illustrates an example of a screen 100 displayed on Bob's client 10 in a case where Bob presses a stamp on “Doc2” in response to Alice's request. At this time, in the chat display field 500, Bob's message 525 “Looks good to me. Signing now.” is displayed. However, even in this example, it is assumed that Bob has a plurality of stamps. Therefore, in the chat display field 500, the message 526 “Please select a stamp” of the server 30 and the stamp option 527 consisting of “Stamp 1” to “Stamp 5” are further displayed.

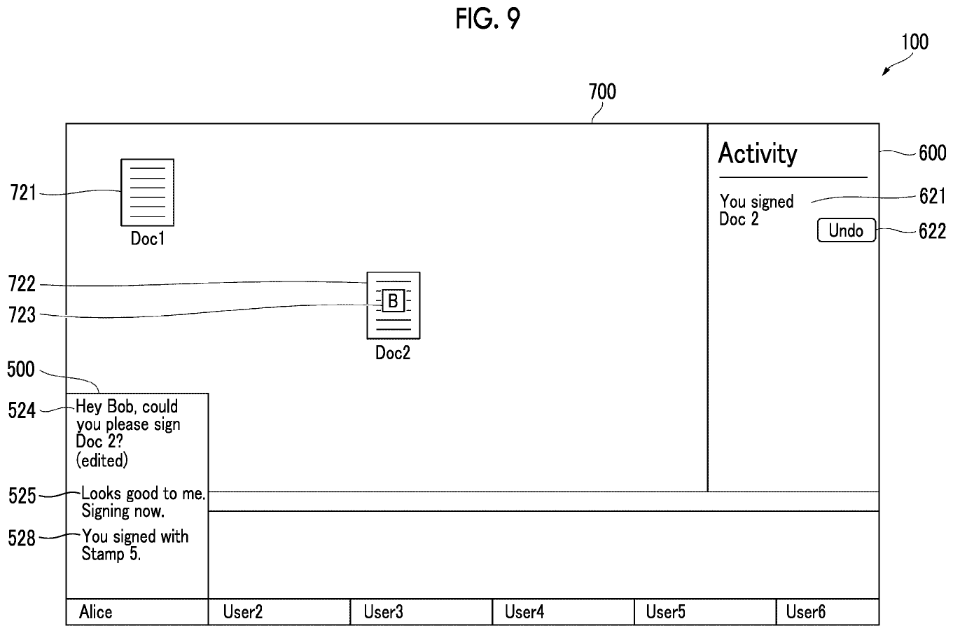

FIG. 9 illustrates an example of the screen 100 displayed on Bob's client 10 in a case where Bob selects “Stamp 5” and presses “Stamp 5” on “Doc2”. At this time, in the chat display field 500, the message 528 of the server 30 “You have signed with Stamp 5” is displayed. Further, in the process history display field 600, a process history 621 saying “You signed Doc2” and an “Undo” button 622 for canceling the process indicated by the process history 621 are displayed. This allows Bob to cancel the process he has instructed in message 525 by clicking the “Undo” button 622. On the other hand, since the “Undo” button is not displayed in the process history display field 600 on the screen 100 of Alice's client 10, Alice cannot cancel the process instructed by Bob. Further, in the processed image display field 700, it is indicated that “Stamp 5” is pressed on “Doc2” by displaying the Bob's “stamp 5” icon 723 superimposed on the “Doc2” icon 722.

Next, the screen 100 displayed in the third scenario will be described. The third scenario is a scenario assuming that Bob tries to press a stamp on a document in response to Alice's request in FIG. 7 but an error occurs.

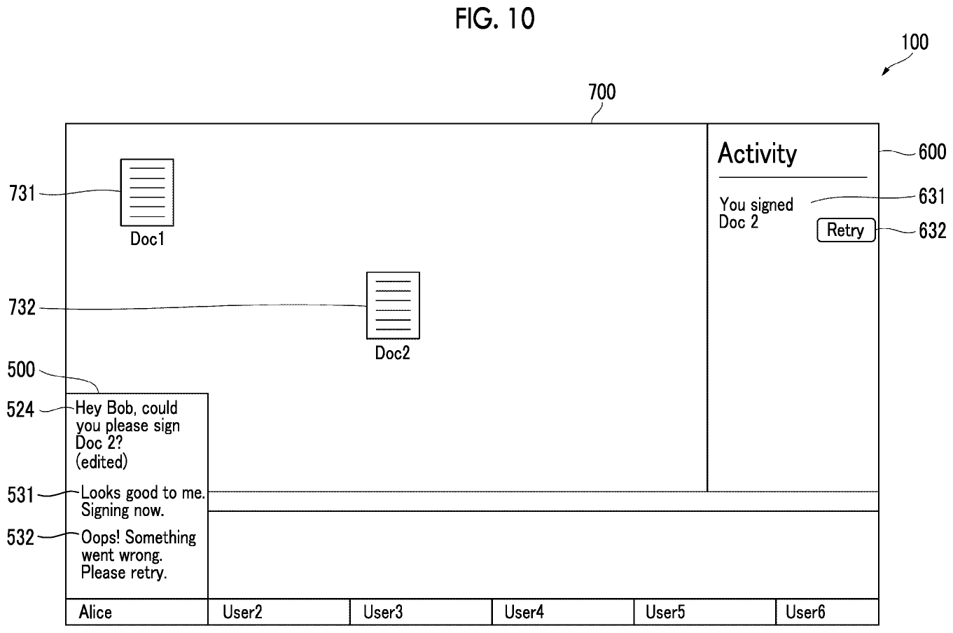

FIG. 10 illustrates an example of the screen 100 displayed on Bob's client 10 in a case where Bob presses a stamp on “Doc2” in response to Alice's request in FIG. 7. At this time, in the chat display field 500, Bob's message 531 “Looks good to me. Signing now.” is displayed. However, in this example, it is assumed that Bob has one stamp. Further, in this example, it is assumed that an error occurs while the server 30 executes a process of pressing a Bob's stamp on “Doc2”. Then, in the chat display field 500, a message 532 of the server 30 “Oops, something has gone wrong. Please try again.” is displayed. Further, in the process history display field 600, a process history 631 saying “You signed Doc2” and a “Retry” button 632 for retrying the process indicated by the process history 631 are displayed. This allows Bob to retry the process he has instructed in message 531 by clicking the “Retry” button 632. On the other hand, since the “Retry” button is not displayed in the process history display field 600 on the screen 100 of Alice's client 10, Alice cannot retry the process instructed by Bob.

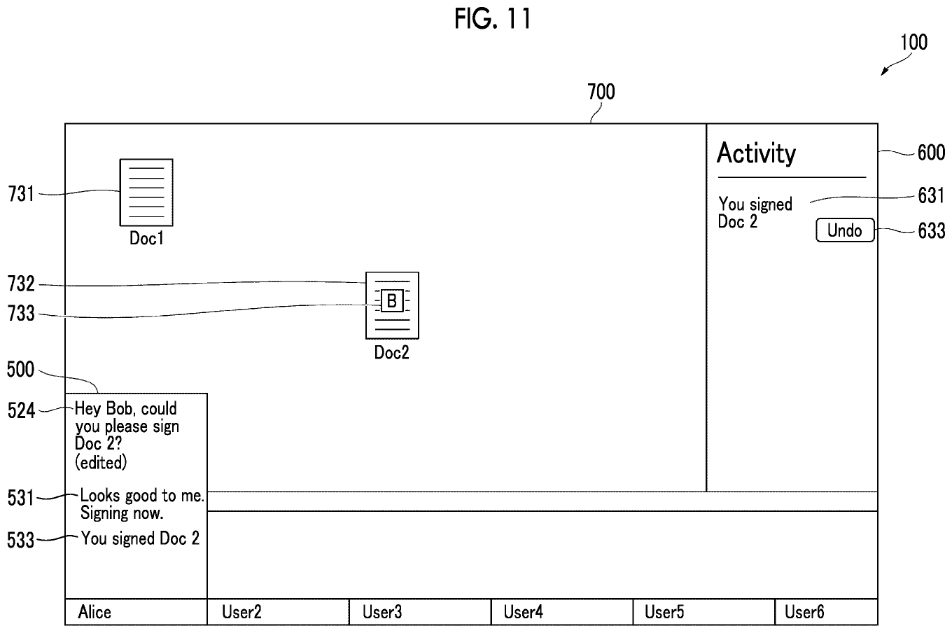

FIG. 11 illustrates an example of a screen 100 displayed on Bob's client 10 in a case where Bob clicks the “Retry” button 632 in FIG. 10. At this time, in the chat display field 500, instead of the message 532 in FIG. 10, the message 533 of the server 30 “You have signed Doc2” is displayed. Further, in the process history display field 600, instead of the “Retry” button 632 of FIG. 10, an “Undo” button 633 for canceling the process indicated by the process history 631 is displayed. This allows Bob to cancel the process he has instructed in message 531 by clicking the “Undo” button 633. On the other hand, since the “Undo” button is not displayed in the process history display field 600 on the screen 100 of Alice's client 10, Alice cannot cancel the process instructed by Bob. Further, in the processed image display field 700, it is indicated that the Bob's stamp is pressed on the “Doc2” by displaying the Bob's stamp icon 733 superimposed on the “Doc2” icon 732.

Functional Configuration Of Server

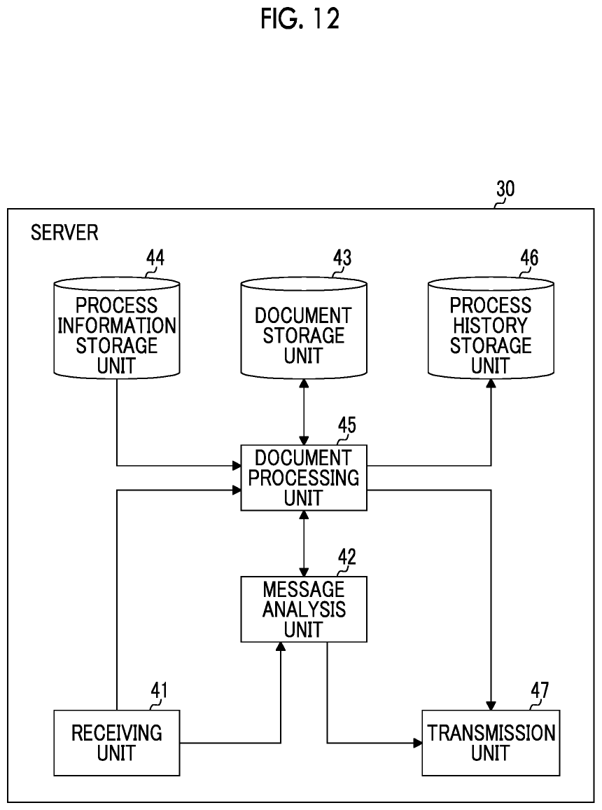

FIG. 12 is a block diagram illustrating a functional configuration example of the server 30 in the present exemplary embodiment. As illustrated in FIG. 12, the server 30 includes a receiving unit 41, a message analysis unit 42, a document storage unit 43, a process information storage unit 44, a document processing unit 45, a process history storage unit 46, and a transmission unit 47.

The receiving unit 41 receives the chat message from the client 10 that is the transmission source of the message (hereinafter, simply referred to as “transmission source client 10”) and delivers the message to the message analysis unit 42. Here, the message also includes a message transmitted as retry information by clicking the “Retry” button on the client 10. In the present exemplary embodiment, this process of the receiving unit 41 is performed as an example of acquiring a message communicated via a communication means between a plurality of users.

Further, the receiving unit 41 receives a message indicating the usage data selected by the user from the plurality of usage data pieces used in the process mentioned in the message from the transmission source client 10, and delivers the message to the document processing unit 45.

Further, the receiving unit 41 receives the cancellation information indicating that the “Undo” button has been clicked on the client 10, from the client 10. Here, the cancellation information includes the process identification information that identifies the process corresponding to the “Undo” button. In the present exemplary embodiment, this process of the receiving unit 41 is performed as an example of receiving the designation of a specific process from the user on the history.

The message analysis unit 42 receives a message from the receiving unit 41, analyzes the message, and determines whether or not the document and process are mentioned in the message. In a case where it is determined that the document and the process are mentioned in the message, the message analysis unit 42 transmits the document and the process to the document processing unit 45 and instructs the transmission unit 47 to transmit the message. In a case where it is determined that at least one of the document or the process is not mentioned in the message, the message analysis unit 42 instructs the transmission unit 47 to transmit a message prompting the supplement of the document or the process not mentioned.

Further, in response to the inquiry from the document processing unit 45, the message analysis unit 42 determines whether the message requests the server 30 to perform a process or the message requests the transmission destination user to perform a process, and returns the determination result to the document processing unit 45.

The document storage unit 43 stores the document to be processed. Here, the document is stored in association with the document identification information that identifies the document. Examples of the document identification information include a document name, document storage location information, and the like. Thus, in a case where the document is mentioned by the document identification information in the message, the document can be acquired based on the document identification information.

The process information storage unit 44 stores process information that is information related to the process performed on the document. Here, the process information includes data used in a case of performing a process (hereinafter, referred to as “usage data”). The process information storage unit 44, for example, may store usage data for each process for each user. The process information storage unit 44 stores, for example, the type of stamp as usage data, for the process of pressing a stamp on a document. In this case, since the type of stamp differs depending on the user, the process information storage unit 44 stores the type of stamp for each user. There may be only one type of stamp or two or more types of stamps. Further, the process information storage unit 44 stores, for example, the information on the destination in a case where the document is sent as usage data, for the process of requesting the transmission destination user to send the document. In this case, since the destination information differs depending on the user, the process information storage unit 44 stores the destination information for each user. There may be only one destination information or two or more types of destination information. Further, the process information storage unit 44 stores the process information without including the usage data, for the process that does not require the usage data.

The document processing unit 45 determines the number of usage data pieces available in the process transmitted from the message analysis unit 42 by referring to the process information storage unit 44.

In a case where it is determined that the number of usage data pieces available in the process is 0, the document processing unit 45 inquires of the message analysis unit 42 whether or not the message requests the server 30 to perform a process.

In a case where it is determined that the number of usage data pieces available in the process is 1, the document processing unit 45 acquires the usage data from the process information storage unit 44. Then, the document processing unit 45 inquires of the message analysis unit 42 whether or not the message requests the server 30 to perform a process.

In a case where it is determined that the number of usage data pieces available in the process is two or more, the document processing unit 45 instructs the transmission unit 47 to transmit a message prompting the selection of one usage data from the two or more pieces of usage data. Thus, in a case where the message indicating the selected usage data is delivered from the receiving unit 41, the document processing unit 45 acquires the selected usage data from the process information storage unit 44. Then, the document processing unit 45 inquires of the message analysis unit 42 whether or not the message first received by the receiving unit 41 requests the server 30 to perform a process.

In a case where the message requests the server 30 to perform a process, the document processing unit 45 instructs the transmission unit 47 to transmit the process history, and acquires the document transmitted from the message analysis unit 42 from the document storage unit 43. Then, the document processing unit 45 executes the process transmitted from the message analysis unit 42 on the acquired document by using the usage data in a case where the usage data has been acquired. In the present exemplary embodiment, this process of the document processing unit 45 is performed as an example of executing the process mentioned in the message on the target mentioned in the message.

In a case where the document is processed in this way, the document processing unit 45 stores the process history in the process history storage unit 46 and instructs the transmission unit 47 to transmit the processing result.

Further, in a case where the process instructed by the user is not executed, even in a case where the receiving unit 41 receives a message as retry information on the process, the document processing unit 45 performs the process identical to the process described above. In the present exemplary embodiment, in a case where the process mentioned in the message is not executed on the target mentioned in the message, this process of the document processing unit 45 is performed as an example of permitting the user to re-execute the process on the target. However, in a case where the process instructed by the user is not executed, the retry information on the process may be transmitted to the user, and the retry information on the process may not be transmitted to the users other than the user. In that sense, this process of the document processing unit 45 is an example of permitting a specific user to re-execute the process, in a case where the process mentioned in the message is not executed on the target mentioned in the message input by a specific user among a plurality of users. Further, this process of the document processing unit 45 is an example of prohibiting users other than a specific user from re-execution of the process, in a case where the process mentioned in the message is not executed on the target mentioned in the message input by a specific user among a plurality of users.

Further, in a case where the receiving unit 41 receives the cancellation information including the process identification information, the document processing unit 45 specifies the process from the process history stored in the process history storage unit 46, based on the process identification information, and cancels the process. At that time, in a case where the identical user has performed a process after that process, these processes may be canceled. Alternatively, in a case where the identical user has performed a process on the identical document after that process, these processes may be canceled. In the present exemplary embodiment, this process of the document processing unit 45 is performed as an example of canceling the process executed by the user's instruction after the specific process.

The process history storage unit 46 stores the process history, which is the history of the process executed by the document processing unit 45. Here, the process history is stored in association with the process history identification information that identifies the process history. Examples of the process history identification information include the time when the process is instructed, the serial number assigned each time the process is instructed, and the like. The process history is also stored in association with the user identification information that identifies the user who has instructed the process. Thus, in a case where the receiving unit 41 receives the process history identification information and the cancellation information accompanied by the user identification information from the client 10, the process history is allowed to be specified based on the process history identification information and the user identification information, and the process indicated in the process history can be cancelled.

In a case where the message received by the receiving unit 41 is delivered from the message analysis unit 42, the transmission unit 47 transmits the message to the transmission destination client 10. Thus, on the transmission destination client 10, the message is displayed in the chat display field 500 on the screen 100.

Further, in a case where the message analysis unit 42 instructs the transmission unit 47 to transmit a message prompting the supplement of the document or process which is not mentioned in the message received from the receiving unit 41, the transmission unit 47 transmits the message prompting the supplement of the document or process, to the transmission source client 10. Thus, on the transmission source client 10, the message prompting the supplement of the document or process is displayed in the chat display field 500 on the screen 100. In the present exemplary embodiment, in a case where a message input by a specific user among a plurality of users does not mention at least one piece of information on a target and a process, as an example of prompting the specific user to designate at least one piece of information, this process of transmission unit 47 is performed.

Further, in a case where the document processing unit 45 instructs the transmission unit 47 to transmit a message prompting the selection of one usage data from among the plurality of usage data pieces available in the document or process which is mentioned in the message received from the receiving unit 41, the transmission unit 47 transmits the message prompting the selection of the usage data to the transmission source client 10. Thus, on the transmission source client 10, a message prompting the selection of the usage data is displayed in the chat display field 500 on the screen 100.

Further, in a case where the document processing unit 45 instructs the transmission unit 47 to transmit the process history, the transmission unit 47 transmits the process history to the transmission source and transmission destination clients 10. Thus, on the transmission source and transmission destination clients 10, the process history is displayed in the process history display field 600 on the screen 100. In the present exemplary embodiment, this process of the transmission unit 47 is performed as an example of controlling the history of the executed processes to be displayed on the identical screen to the screen on which the message is displayed.

Further, in a case where the document processing unit instructs the transmission unit 47 to transmit the processing result, the transmission unit 47 transmits the processing result to the transmission source and transmission destination clients 10. Thus, on the transmission source and transmission destination clients 10, a message indicating the processing result is displayed in the chat display field 500 on the screen 100, and an image illustrating the processing result is displayed in the processed image display field 700 on the screen 100. In the present exemplary embodiment, this process of the document processing unit 45 is performed as an example of performing a control to display that the process has been performed on the target.

Server Operation

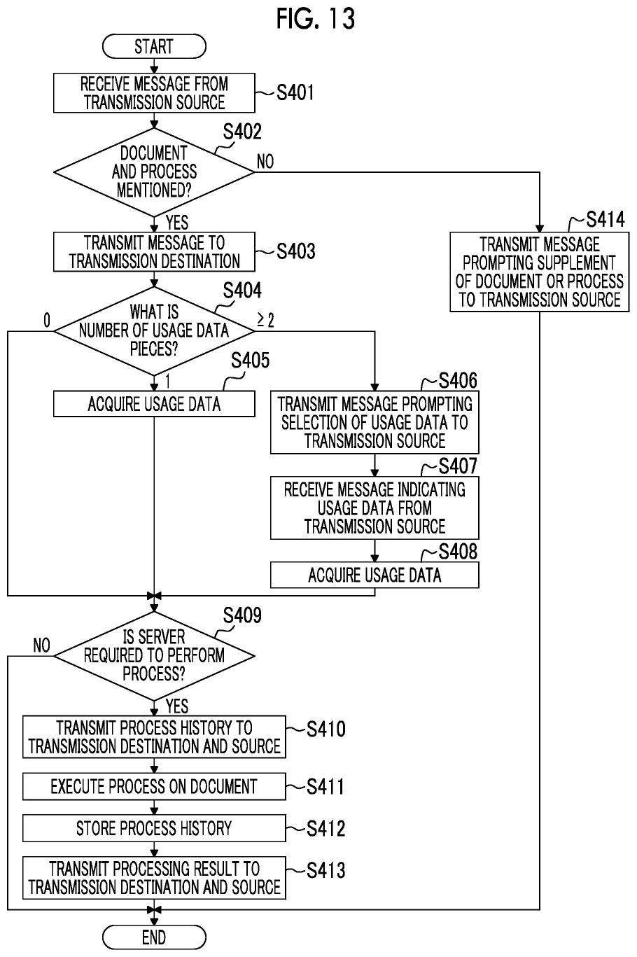

FIG. 13 is a flowchart illustrating an operation example of the server 30 in the present exemplary embodiment.

As illustrated in FIG. 13, in the server 30, first, the receiving unit 41 receives the message from the transmission source client 10 (step S401).

Next, the message analysis unit 42 determines whether or not the message received in step S401 mentions the document and process (step S402).

As a result, in a case where it is determined in step S402 that the document and the process are mentioned in the message received in step S401, the transmission unit 47 transmits the message to the transmission destination client 10 (step S403).

Next, the document processing unit 45 refers to the process information storage unit 44 to determine the number of usage data pieces available in the process specified in step S402 (step S404).

In a case where it is determined that the number of usage data pieces available in step S404 is 0, that is, the usage data is not needed, the process proceeds to step S409.

In a case where it is determined in step S404 that the number of usage data pieces is 1, the document processing unit 45 acquires the one usage data from the process information storage unit 44 (step S405). Then, the process proceeds to step S409.

In a case where it is determined in step S404 that the number of usage data pieces is 2 or more, the transmission unit 47 transmits a message prompting the selection of the usage data from the two or more usage data pieces, to the transmission source client 10 (step S406). As a result, in a case where the user of the transmission source selects the usage data, the receiving unit 41 receives a message indicating the selected usage data from the transmission source client 10 (step S407). Then, the document processing unit 45 acquires the selected usage data from the process information storage unit 44 (step S408). Then, the process proceeds to step S409.

Next, the message analysis unit 42 determines whether or not the message received in step S401 requests the server 30 to perform the process specified in step 402 (step S409).

In a case where it is not determined in step S409 that the message requests the server 30 to perform the process, that is, in a case where it is determined that the message requests the transmission destination user to perform the process, the process ends. In this operation example, even in a case where it is determined that the message requests the transmission destination user to perform a process, the process of steps 404 to 408 is performed. That is because even in a case where the message requests the transmission destination user to perform a process, for example, in a case where the process mentioned in the message is the process of sending the document to the destination, the usage data such as the destination information is acquired.

In a case where it is determined in step S409 that the message requests the server 30 to perform the process, the transmission unit 47 transmits the process history to the transmission source and transmission destination clients 10 (step S410).

Further, the document processing unit 45 executes the process specified in step S402 on the document specified in step S402 (step S411). Here, the document processing unit 45, for example, may acquire the document specified in step S402 from the documents stored in the document storage unit 43. Further, in a case where the usage data is acquired in step S405 or step S408, for example, the document processing unit 45 may execute the process by using the usage data.

Further, the document processing unit 45 stores the process history, which is the history of the process in step S411, in the process history storage unit 46 (step S412).

Further, the transmission unit 47 transmits the processing result, which is the result of the process in step S411, to the transmission source client 10 and the transmission destination client 10 (step S413). In this case, on the transmission source client 10, in a case where the processing result is normally received, for example, the “Undo” button may be displayed in the process history display field 600 in association with the process history transmitted in step S410. On the other hand, on the transmission source client 10, in a case where the processing result is not normally received and a timeout occurs, for example, the “Retry” button may be displayed in association with the process history transmitted in step S410.

After the above process is performed, the process ends.

On the other hand, in a case where it is not determined in step S402 that the message received in step S401 mentions the document and the process, the transmission unit 47 transmits a message prompting the supplement of the document or the process which is are not mentioned, to the transmission source client 10 (step S414). Then, the process ends.

Here, the operation example illustrated in FIG. 13 will be specifically described with reference to the first scenario described above.

In the first scenario, in a case where the message 511 is input to the chat display field 500 by the Alice's client 10, the receiving unit 41 receives the message 511 from the Alice's client 10 in step S401.

Next, the message analysis unit 42 determines in step S402 that the document and process are mentioned in the message 511. Here, it is determined that the document is mentioned because the document name “Doc1” is included in the message 511. Further, it is determined that the process is mentioned because the message 511 includes “signing” indicating the process of pressing the stamp.

Then, the transmission unit 47 transmits the message 511 to Bob's client 10 in step S403. Thus, as illustrated in FIG. 3, the message 511 is displayed in the chat display field 500 of Bob's client 10.

Next, in step S404, the document processing unit 45 refers to the process information storage unit 44 to determine the number of usage data pieces available in the process of pressing the stamp. Here, it is assumed that the number of Alice's stamps available in the process of pressing a stamp is one.

Then, in step S405, the document processing unit 45 acquires the one stamp from the process information storage unit 44.

Next, the message analysis unit 42 determines in step S409 that the message 511 requests the server 30 to perform a process.

Then, in step S410, the transmission unit 47 transmits the process history 611 to Alice's client 10 and Bob's client 10. Thus, as illustrated in FIG. 3, the process history 611 is grayed out and displayed in the process history display field 600 of Bob's client 10.

In addition, the document processing unit 45 executes a process of pressing Alice's stamp on “Doc1” in step S411. Further, the document processing unit 45 stores the process history in the process history storage unit 46 in step S412. Further, in step S413, the transmission unit 47 transmits, to Alice's client 10 and Bob's client 10, the processing result indicating that the process of pressing Alice's stamp on “Doc1” has been executed. Thus, as illustrated in FIG. 3, in the processed image display field 700 of Bob's client 10, an image in which the icon 713 is superimposed on the icon 711 is displayed.

Next, as illustrated in FIG. 4, in a case where the message 512 is input to the chat display field 500 by Bob's client 10, the receiving unit 41 receives the message 512 from Bob's client 10 in step S401.

Next, the message analysis unit 42 determines in step S402 that the document and process are mentioned in the message 512. Here, it is determined that the document is mentioned because it can be determined that the processing target is “Doc1” in the context from the message 512. Further, it is determined that the process is mentioned because the message 512 includes “Signing” indicating the process of pressing the stamp.

Then, in step S403, the transmission unit 47 transmits the message 512 to Alice's client 10.

Next, in step S404, the document processing unit 45 refers to the process information storage unit 44 to determine the number of usage data pieces available in the process of pressing the stamp. Here, it is assumed that the number of Bob's stamps available in the process of pressing a stamp is five.

Then, in step S406, the document processing unit 45 sends a message 513 prompting the selection of one stamp from among the five stamps to Bob's client 10. Thus, as illustrated in FIG. 4, the message 513 is displayed in the chat display field 500 of Bob's client 10. Here, in a case where Bob selects one stamp, the receiving unit 41 receives a message indicating the selected stamp, in step S407. Then, in step S408, the document processing unit 45 acquires the selected stamp from the process information storage unit 44.

Next, the message analysis unit 42 determines in step S409 that the message 512 requests the server 30 to perform a process.

Then, in step S410, the transmission unit 47 transmits the process history 612 to Alice's client 10 and Bob's client 10. Thus, as illustrated in FIG. 5, the process history 612 is displayed in the process history display field 600 of Bob's client 10.

In addition, the document processing unit 45 executes a process of pressing Bob's stamp on “Doc1” in step S411. Further, the document processing unit 45 stores the process history in the process history storage unit 46 in step S412. Further, in step S413, the transmission unit 47 transmits, to Alice's client 10 and Bob's client 10, the processing result indicating that the process of pressing Bob's stamp on “Doc1” has been executed. Thus, as illustrated in FIG. 5, the message 515 is displayed in the chat display field 500 of Bob's client 10, and an image in which the icons 713 and 714 are superimposed on the icon 711 is displayed in the processed image display field 700 of Bob's client 10. In this case, the “Undo” button 613 is also displayed in the process history display field 600 of Bob's client 10.

Next, the operation example illustrated in FIG. 13 will be specifically described with reference to the second scenario described above.

In the second scenario, as illustrated in FIG. 6, in a case where the message 521 is input to the chat display field 500 by the Alice's client 10, the receiving unit 41 receives the message 521 from the Alice's client 10 in step S401.

Next, in step S402, the message analysis unit 42 determines that the document is not mentioned but the process is mentioned, in the message 521. Here, it is determined that the document is not mentioned because the document name is not included in the message 521 and cannot be determined from the context. Further, it is determined that the process is mentioned because the message 521 includes “sign” indicating the process of pressing the stamp.

Then, in step S414, the transmission unit 47 transmits a message 522 prompting the user to supplement the document name to the transmission source client 10. Thus, as illustrated in FIG. 6, the message 522 is displayed in the chat display field 500 of Alice's client 10.

Next, as illustrated in FIG. 6, in a case where the message 523 indicating “Doc2” is input to the chat display field 500 by the Alice's client 10, the message 521 of FIG. 6 is edited. As a result, as illustrated in FIG. 7, in a case where the message 524 is input to the chat display field 500 by the Alice's client 10, the receiving unit 41 receives the message 524 from the Alice's client 10 in step S401.

Next, the message analysis unit 42 determines in step S402 that the document and process are mentioned in the message 524. Here, it is determined that the document is mentioned because the document name “Doc2” is included in the message 524. Further, it is determined that the process is mentioned because the message 524 includes “sign” indicating the process of pressing the stamp.

Then, the transmission unit 47 transmits the message 524 to Bob's client 10 in step S403. Thus, as illustrated in FIG. 8, the message 524 is displayed in the chat display field 500 of Bob's client 10.

After that, the message analysis unit 42 determines in step S409 that the message 524 does not request the server 30 to perform a process.

Next, as illustrated in FIG. 8, the message 525 is input to the chat display field 500 by Bob's client 10. Subsequent operations are basically identical to the operations in a case where the message 512 is input to the chat display field 500 of Bob's client 10 in FIG. 4, so the description thereof will be omitted.

Next, the operation example illustrated in FIG. 13 will be specifically described with reference to the third scenario described above.

In the third scenario, as illustrated in FIG. 10, in a case where the message 531 is input to the chat display field 500 by the Bob's client 10, the receiving unit 41 receives the message 531 from the Bob's client 10 in step S401.

Next, the message analysis unit 42 determines in step S402 that the document and process are mentioned in the message 531. Here, it is determined that the document is mentioned because it can be determined that the processing target is “Doc2” in the context from the message 531. Further, it is determined that the process is mentioned because the message 531 includes “Signing” indicating the process of pressing the stamp.

Then, in step S403, the transmission unit 47 transmits the message 531 to Alice's client 10.

Next, in step S404, the document processing unit 45 refers to the process information storage unit 44 to determine the number of usage data pieces available in the process of pressing the stamp. Here, it is assumed that the number of Bob's stamps available in the process of pressing a stamp is one.

Then, in step S405, the document processing unit 45 acquires the one stamp from the process information storage unit 44.

Next, the message analysis unit 42 determines in step S409 that the message 531 requests the server 30 to perform a process.

Then, in step S410, the transmission unit 47 transmits the process history 631 to Alice's client 10 and Bob's client 10. Thus, as illustrated in FIG. 10, the process history 631 is displayed in the process history display field 600 of Bob's client 10.

In addition, the document processing unit 45 executes a process of pressing Bob's stamp on “Doc2” in step S411. Here, it is assumed that an error occurs during a process. Then, on the Bob's client 10, since the normal processing result is not received, a message 532 indicating the occurrence of an error is displayed in the chat display field 500, and a “Retry” button 632 for retrying the process is displayed in the process history display field 600.

Next, in a case where the “Retry” button 632 is clicked in FIG. 10, the receiving unit 41 receives the message 531 from Bob's client 10 in step S401.

Next, the message analysis unit 42 determines in step S402 that the document and process are mentioned in the message 531.

Then, in step S403, the transmission unit 47 transmits the message 531 to Alice's client 10.

Next, in step S404, the document processing unit 45 refers to the process information storage unit 44 to determine the number of usage data pieces available in the process of pressing the stamp. Here, it is assumed that the number of Bob's stamps available in the process of pressing a stamp is one.

Then, in step S405, the document processing unit 45 acquires the one stamp from the process information storage unit 44.

Next, the message analysis unit 42 determines in step S409 that the message 531 requests the server 30 to perform a process.

Then, in step S410, the transmission unit 47 transmits the process history 631 to Alice's client 10 and Bob's client 10. Thus, as illustrated in FIG. 11, the process history 631 is displayed in the process history display field 600 of Bob's client 10.

In addition, the document processing unit 45 executes a process of pressing Bob's stamp on “Doc2” in step S411. Here, it is assumed that no error has occurred during processing. Then, the document processing unit 45 stores the process history in the process history storage unit 46 in step S412. Further, in step S413, the transmission unit 47 transmits, to Alice's client 10 and Bob's client 10, the processing result indicating that the process of pressing Bob's stamp on “Doc2” has been executed. Thus, as illustrated in FIG. 11, the message 533 is displayed in the chat display field 500 of Bob's client 10, and an image in which the icon 733 is superimposed on the icon 732 is displayed in the processed image display field 700 of Bob's client 10. In this case, the “Undo” button 633 is also displayed in the process history display field 600 of Bob's client 10.

Next, an operation example in a case where the “Undo” button of the server 30 in the present exemplary embodiment is clicked will be described.

In a case where the “Undo” button is clicked on the client 10 and the cancellation information including the process identification information that specifies the process to be canceled is transmitted, the receiving unit 41 first receives the cancellation information on the server 30. Then, the document processing unit 45 specifies the process identified by the process identification information included in the cancellation information, from the process history stored in the process history storage unit 46, and cancels the process.

Processor

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Program

The process performed by the server 30 in the present exemplary embodiment is prepared as, for example, a program such as application software.

That is, the program that achieves the present exemplary embodiment can be regarded as a program causing a computer to achieve a function of acquiring a message communicated via a communication means between a plurality of users; a function of executing a process mentioned in the message on a target mentioned in the message; and a function of performing a control to display that the process has been performed on the target.

The program that achieves the present exemplary embodiment can be provided not only via a communication means but also by storing the program in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a message communicated via a communication means between a plurality of users;
execute a process mentioned in the message on a target mentioned in the message; and
perform a control to display that the process has been performed on the target.

2. The information processing apparatus according to claim 1, wherein the processor is configured to:
in a case where there are a plurality of process candidates as candidates for the process, execute one process candidate selected from among the plurality of process candidates on the target.

3. The information processing apparatus according to claim 2, wherein
each process candidate of the plurality of process candidates is a candidate for performing the process, by using data corresponding to each process candidate among a plurality of data pieces.

4. The information processing apparatus according to claim 1, wherein the processor is configured to:
in a case where there are a plurality of target candidates as candidates for the target, execute the process on one target candidate selected from among the plurality of target candidates.

5. The information processing apparatus according to claim 1, wherein the processor is configured to:
in a case where a message input by a specific user among the plurality of users does not mention at least one piece of information on a target or a process, prompt the specific user to designate the at least one piece of information.

6. The information processing apparatus according to claim 1, wherein the processor is configured to:
in a case where the process mentioned in the message is not executed on the target mentioned in the message, and an instruction is received from a user, re-execute the process on the target.

7. The information processing apparatus according to claim 6, wherein the processor is configured to:
in a case where the process mentioned in the message input by a specific user among the plurality of users is not executed on the target mentioned in the message, permit the specific user to re-execute the process on the target.

8. The information processing apparatus according to claim 6, wherein the processor is configured to:
in a case where the process mentioned in the message input by a specific user among the plurality of users is not executed on the target mentioned in the message, prohibit users other than the specific user from re-executing the process on the target.

9. The information processing apparatus according to claim 1, wherein the processor is configured to:
perform a control such that a history of the executed process is displayed on an identical screen to a screen on which the message is displayed.

10. The information processing apparatus according to claim 9, wherein the processor is configured to:
receive designation of a specific process from the user on the history; and
cancel the process executed in response to a user's instruction after the specific process.

11. A non-transitory computer readable medium storing a program causing a computer to execute a process comprising:
acquiring a message communicated via a communication means between a plurality of users;
executing a process mentioned in the message on a target mentioned in the message; and
performing a control to display that the process has been performed on the target.

12. An information processing apparatus comprising:
means for acquiring a message communicated via a communication means between a plurality of users;
means for executing a process mentioned in the message on a target mentioned in the message; and
means for performing a control to display that the process has been performed on the target.
